(19) United States
(12) Patent Application Publication
(10) Pub. No.: US 2016/0142361 A1
(43) Pub. Date: May 19, 2016

(54) IMAGE WITH AUDIO CONVERSATION SYSTEM AND METHOD UTILIZING SOCIAL MEDIA COMMUNICATIONS

(71) Applicants: Andrew Grossman, Hopkins, MN (US); Kenneth F. Krutsch, Minnetonka, MN (US); Harish Manepalli, Eden Prairie, MN (US)

(72) Inventors: Andrew Grossman, Hopkins, MN (US); Kenneth F. Krutsch, Minnetonka, MN (US); Harish Manepalli, Eden Prairie, MN (US)

(73) Assignee: FILMSTRIP, INC., Minneapolis, MN (US)

(21) Appl. No.: 14/542,599

(22) Filed: Nov. 15, 2014

(51) Int. Cl. H04L 12/58; H04L 29/06; H04L 29/08

(52) U.S. Cl. CPC H04L 51/32; H04L 51/10; H04L 67/02; H04L 67/42

(57) ABSTRACT

A system and method are presented that use an existing social networking message system to allow interactive audio commentary concerning a visual image. Audio is rendered into a video file containing the image. This video file is provided to a web page generation server that creates a web page containing the video file and appropriate metadata. A social networking message containing a link to the web page is sent over the existing message system. Existing applications read the social networking message, follow the link, read the metadata, and allow readers to play the video file. Users are encouraged to view the message using an app that can record a reply audio track. Recorded reply messages are added to the social networking message in the same manner as the original audio. Audio commentary concerning an image can also be added to a web page or blog post through a widget.

### RELATED APPLICATION

This application is related to the content found in U.S. patent application Ser. No. 14/521,576, filed on (Oct. 23, 2014); U.S. patent application Ser. No. 14/179,602, filed on (Feb. 23, 2014); U.S. patent application Ser. No. 14/043,385 (filed on Oct. 1, 2013); U.S. patent application Ser. Nos. 13/832,177, 13/832,744, and 13/834,347 (all filed on Mar. 15, 2013); and U.S. patent application Ser. No. 13/947,016 (filed on Jul. 19, 2013), all of which are hereby incorporated by reference.

### FIELD OF THE INVENTION

The present application relates to the field of image-centered audio communications between users. More particularly, the described embodiments relate to a system and method for image-centered, bi-directional audio communications that are communicated over existing social networking Internet services, or are embedded as HTML widgets into existing blog or web pages.

### SUMMARY

One embodiment of the present invention provides audio communication between users concerning an image. The originator of the communication uses an audio-image app operating on a mobile device or computer to create or select a photograph or other image. The same app is then used to attach an audio commentary to the image. In one embodiment, the app encodes the audio commentary and the image together into a video file. This video file is transmitted to a web server that places the file on a web page along with associated metadata necessary to present the video file through an existing social media Internet service. The app also transmits the audio, image, and metadata information to an audio-image server that separately maintains the data.

The originator is then able to post the image, along with a textual message, to the social networking service. In one implementation, the social networking service does not allow the ability to incorporate video or still images directly into social networking messages. Rather URL links are provided to the video or image file. If the link is to a web page that incorporates the appropriate metadata, the social networking app will be able to directly display the media to the user when the user is viewing the message. In these implementations, the audio-image app incorporates a link to the web server within the text of the posted message.

When a recipient user views this message, the social networking application will display the linked-to video file directly from the web server. This allows the user to consume the audio-image experience within the social networking application. The social networking application will also be able to identify whether the recipient has access to the audio-image app on their current device. If so, a link will be provided to open the audio-image message within the audio-image app. If not, a message will be displayed indicating that an audio reply can be created if the user were to download the audio-image app. This message will include a link to an app store where the app can be downloaded.

When the user elects to view the audio-image message in the audio-image app, the social networking application will communicate a message identifier to the audio-image app. This allows the app to access the original data and files from the audio-image server. The audio-image app will allow the user to record an audio response to the audio-image message. The audio-image application is able to send the audio-image response to recipients either over the social networking platform or directly through the audio-image server, or through both channels simultaneously.

The audio-image app is able to directly access the in-box (or “feed”) of the user's social networking account to determining if any of the social networking messages contain a link to the audio-image website. If so, the audio-image app will know that the message relates to an audio-image message. The audio-image messages that are received through the social networking platform can be viewed as an in-box/feed within the audio-image app, thereby allowing users of the audio-image app to immediately identify and handle social networking messages that contain audio-image data.

It is also possible to generate code in the form of a widget that can incorporate the features of an audio-image message within a user's blog. An audio-image widget can allow a blogger to insert a visual element into their blog along with an audio message. This data is stored on the audio-image server. Users viewing the blog can “play” the audio-image, which causes the widget to receive the data from the audio-image server and play the appropriate audio file. The widget will also allow a reader of the blog to add his or her own audio reply to the audio-image content. The newly created audio reply is stored on the audio-image server.

Bloggers may wish to “pin” their images to a social image-sharing web site. Currently, images that are pinned to these sites may not include their own widgets, but do include a link back to an originating page. By first created a blog entry concerning an image using the audio-image widget, and then pining the image in the social image-sharing web site with a link back to the blog entry, readers of the social networking image sharing site can enjoy the benefits of the audio-image messaging system.

### BRIEF DESCRIPTION OF THE DRAWINGS

FIG. 1 is a schematic view of a system utilizing the present invention.

FIG. 2 is a schematic diagram of the system shown in FIG. 1 used in the context of communicating audio-image messages over a social networking messaging system.

FIG. 3 is a schematic diagram of a portion of the system shown in FIG. 2, with additional details on data content.

FIG. 4 is a plan view of a mobile device displaying a user interface provided by a social networking app.

FIG. 5 is a plan view of the mobile device of FIG. 4 displaying a user interface provided by an audio-image app.

FIG. 6 is a plan view of the mobile device of FIG. 5, displaying a second user interface provided by the audio-image app.

FIG. 7 is a flow chart showing a method of handling a social networking message relating to audio-image content.

FIG. 8 is a flow chart showing the detailed steps of creating and sending an audio replay to the social networking message handled in the method of claim 6.

FIG. 9 is a schematic view of a web site interface provided by a web server for viewing audio-image content.

FIG. 10 is a schematic view of a second web site interface provided by the web server that allows for the creation of an audio response to audio-image content.

FIG. 11 is a schematic view of a blogging web site interface utilizing an audio-image widget for presentation of audio-image content.

FIG. 12 is a schematic view of a blogging web site interface utilizing an audio-image widget for creation of audio-image content.

FIG. 13 is a flow chart showing a method of creating a blog entry utilizing an audio-image widget.

FIG. 14 is a schematic view of a web site interface providing by a social networking image sharing website when displaying a pinned image created by the audio-image widget.

FIG. 15 is a flow chart showing a method for sharing audio-image content through a social networking image sharing website.

### DETAILED DESCRIPTION

### System 100

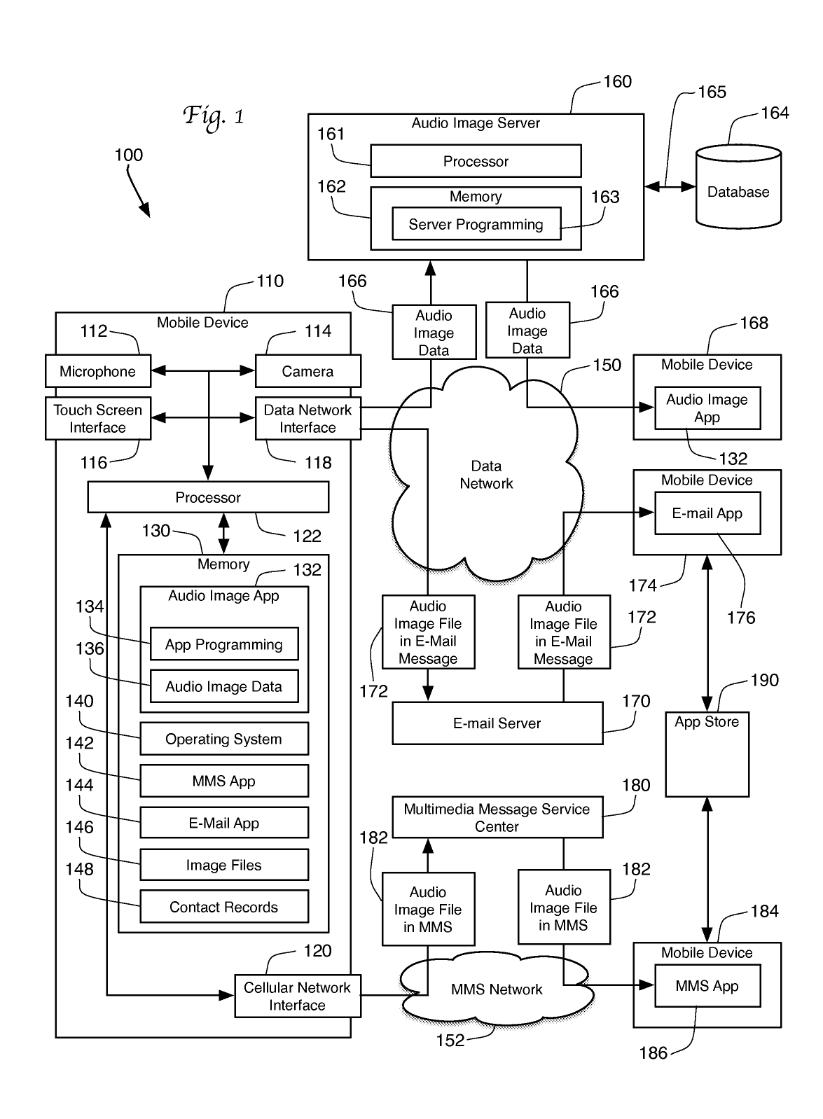

FIG. 1 shows a system 100 that was originally described in the patent applications that were incorporated above. This Figure does not disclose any interaction with the social networking platform, but it provides a background for the interactions that are possible using the audio-image app.

In FIG. 1, a mobile device 110 can create and transmit audio-image files to other users. Audio-image files allow users to have a bi-directional, queued, audio communication about a particular visual image or presentation. The mobile device 110 can communicate over a wide area data network 150 with a plurality of computing devices. In FIG. 1, the mobile device 110 communicates over network 150 with an audio-image server 160 to send an audio-image to mobile device 168, and communicates over the same network 150 with an e-mail server 170 in order to send an e-mail containing an audio-image to a second mobile device 174. In one embodiment, the wide area data network is the Internet. This same data network 150 is also used to communicate over the social networking platform, as is described in more detail below. The mobile device 110 is also able to communicate with a multimedia messaging service center (“MMS center”) 180 over MMS network 152 in order to send an audio-image within an MMS message to a third mobile device 184.

The mobile device 110 can take the form of a smart phone or tablet computer that includes a microphone 112 and a camera 114 for receiving audio and visual inputs. The device 110 also includes a touch screen user interface 116. In the preferred embodiment, touch screen 116 both presents visual information to the user over the display portion of the touch screen 116 and also receives touch input from the user.

The mobile device 110 communicates over the data network 150 through a data network interface 118. In one embodiment, the data network interface 118 connects the device 110 to a local wireless network that provides connection to the wide area data network 150. The data network interface 118 preferably connects via one of the Institute of Electrical and Electronics Engineers' (IEEE) 802.11 standards. In one embodiment, the local network is based on TCP/IP, and the data network interface 118 utilizes a TCP/IP protocol stack.

Similarly, the mobile device 110 communicates over the MMS network 152 via a cellular network interface 120. In the preferred embodiment, the mobile device 110 sends multi-media messaging service (“MMS”) messages via the standards provided by a cellular network 152, meaning that the MMS network 152 used for data messages is the same network 152 that is used by the mobile device 110 to make cellular voice calls. In some embodiments, the provider of the cellular data network also provides an interface to the wide area data network 150, meaning that the MMS or cellular network 152 could be utilized to send e-mail and proprietary messages as well as MMS messages. This means that the actual physical network interface 118, 120 used by the mobile device 110 is relatively unimportant. Consequently, the following description will focus on messaging without necessarily limiting these messages to a particular network 150, 152 or network interface 118, 120. The use of particular interfaces 118, 120 and networks 150, 152 in this description is merely exemplary.

The mobile device 110 further includes a processor 122 and a memory 130. The processor 120 can be a general purpose CPU, such as those provided by Intel Corporation (Mountain View, Calif.) or Advanced Micro Devices, Inc. (Sunnyvale, Calif.), or a mobile specific processor, such as those designed by ARM Holdings (Cambridge, UK). Mobile devices such as device 110 generally use specific operating systems 140 designed for such devices, such as iOS from Apple Inc. (Cupertino, Calif.) or ANDROID OS from Google Inc. (Menlo Park, Calif.). The operating system 140 is stored on memory 130 and is used by the processor 120 to provide a user interface for the touch screen display 116, handle communications for the device 110, and to manage and provide services to applications (or apps) that are stored in the memory 130. In particular, the mobile device 110 is shown with an audio-image app 132, MMS app 142, and an e-mail app 144. The MMS app 142 is responsible for sending, receiving, and managing MMS messages over the MMS network 152. Incoming messages are received from the MMS center 180, which temporarily stores incoming messages until the mobile device 110 is able to receive them. Similarly, the e-mail app 144 sends, receives, and manages e-mail messages with the aid of one or more e-mail servers 170.

The audio-image app 132 is responsible for the creation of audio-image files, the management of multiple audio-image files, and the sending and receiving of audio-image files. In one embodiment, the audio-image app 132 contains programming instructions 134 for the processor 122 as well as audio-image data 136. The image data 136 will include all of the undeleted audio-image files that were created and received by the audio-image app 132. In the preferred embodiment, the user is able to delete old audio-image files that are no longer desired in order to save space in memory 130.

The app programming 134 instructs the processor 122 how to create audio-image files. The first step in so doing is either the creation of a new image file using camera 114, or the selection of an existing image file 146 accessible by the mobile device 110. The existing image file 146 may be retrieved from the memory 130 of the mobile device 110, or from a remote data storage service (not shown in FIG. 1) accessible over data network 150. The processor 122 then uses the display 116 to show the image to the user, and allows the user to input an audio commentary using the microphone 112. The app programming 134 instructs the processor 122 how to combine the recorded audio data with the image into an audio-image file. In some embodiments, the audio-image file will take the form of a standard video file. In the preferred embodiment, the app programming 134 takes advantage of the ability to link to existing routines in the operating system 140 in order to render this video file. In most cases, these tools take the form of a software development kit (or “SDK”) or access to an application programming interface (or “API”). For example, Apple's iOS gives third-party apps access to an SDK to render videos using the H.264 video codec.

After the app programming 134 causes the processor 122 to create the video file (one type of an audio-image file), the app programming 134 causes the processor 122 to present a user input screen on display 116 that allows the user to select a recipient of the audio-image file. In one embodiment, the user is allowed to select recipients from existing contact records 148 that already exist on the mobile device 110. These same contact records may be used by the MMS app 142 to send MMS messages and the E-mail app 144 to send e-mail messages. In one embodiment, when the user selects a contact as a recipient, the app programming 134 identifies either an e-mail address or a cell phone number for the recipient.

Once the recipient is identified, the app 132 determines whether the audio-image file should be sent to the recipient using the audio-image server 160 and its proprietary communications channel, or should be sent via e-mail or MMS message. This determination may be based on whether or not the recipient mobile device is utilizing the audio-image app 132. A mobile device is considered to be using the audio-image app 132 if the app 132 is installed on the device and the user has registered themselves as a user of the app 132 with the audio-image server 160. In FIG. 1, mobile device 168 is using the audio-image app 132, while mobile devices 174 and 184 are not using the app 132.

To make this determination, the app programming 134 instructs the processor 122 to send a user verification request containing a recipient identifier (such the recipient's e-mail address or cell phone of the recipient, either of which could be considered the recipient's “audio-image address”) to the audio-image server 160. The server 160 is a programmed computing device operating a processor 161 under control of server programming 163 that is stored on the memory 162 of the audio-image server 160. The processor 161 is preferably a general purpose CPU of the type provided by Intel Corporation or Advanced Micro Devices, Inc., operating under the control of a general purpose operating system such as Mac OS by Apple, Inc., Windows by Microsoft Corporation (Redmond, Wash.), or Linux (available from a variety of sources under open source licensing restrictions). The server 160 is in further communication with a database 164 that contains information on audio-image users, the audio-image addresses of the users, and audio-image files. The server 160 responds to the user verification request by consulting the database 164 to determine whether each recipient's audio-image address is associated in the database 164 with a known user of the app 132. The server 160 then informs the mobile device 110 of its findings.

Although the server 160 is described above as a single computer with a single processor 161, it would be straightforward to implement server 160 as a plurality of separate physical computers operating under common or cooperative programming. Consequently, the terms server, server computer, or server computers should all be viewed as covering situations utilizing one or more than one physical computer.

If the server 160 indicates that the recipient device 168 is associated with a known user of the app 132, then, in one embodiment, the audio-image file 166 is transmitted to that mobile device 168 via the server 160. To do so, the mobile device 110 transmits to the server 160 the audio-image video file along with metadata that identifies the sender and recipient of the file 166. The server 160 stores this information in database 164, and informs the recipient mobile device 168 that it has received an audio-image file 166. If the device 168 is powered on and connected to the data network 150, the audio-image file 166 can be immediately transmitted to the mobile device 168, where it is received and managed by the audio-image app 132 on that device 168. The audio-image app 132 would then inform its user that the audio-image file is available for viewing. In the preferred embodiment, the app 132 would list all received audio-image files in a queue for selection by the user. When one of the files is selected, the app 132 would present the image and play the most recently added audio commentary made about that image. The app 132 would also give the user of device 168 the ability to record a reply commentary to the image, and then send that reply back to mobile device 110 in the form of a new audio-image file. The new audio-image file containing the reply comment could also be forwarded to third parties.

If the server 160 indicates that the recipient device 174 or 184 is not associated with a user of the audio-image app 132, the mobile device 110 will send the audio-image file without using the proprietary communication system provided by the audio-image server 160. If the audio-image address is an e-mail address, the audio-image app 132 on device 110 will create an e-mail message 172 to that address. This e-mail message 172 will contain the audio-image file as an attachment, and will be sent to an e-mail server 170 that receives e-mail for the e-mail address used by device 174. This server 170 would then communicate to the device 174 that an e-mail has been received. If the device 174 is powered on and connected to the data network 150, an e-mail app 176 on the mobile device 174 will receive and handle the audio-image file within the received e-mail message 172.

Similarly, if the audio-image address is a cell phone number, the audio-image app 132 will create an MMS message 182 for transmission through the cellular network interface 120. This MMS message 182 will include the audio-image file, and will be delivered to an MMS center 180 that receives MMS messages for mobile device 184. If the mobile device 184 is powered on and connected to the MMS network 152, an MMS app 186 on mobile device 184 will download and manage the MMS message 182 containing the audio-image file 182. Because the audio-image file in either the e-mail message 172 and the MMS message 182 is a standard video file, both mobile devices 174 and 184 can play the file using standard programming that already exists on the devices 174, 184. This will allow the devices 174, 184 to display the image and play the audio commentary concerning the image as input by the user of device 110 without requiring the presence of the audio-image app 132. However, without the presence of the app 132, it would not be possible for either device 174, 184 to easily compose a reply audio-image message that could be sent back to device 110.

In the preferred embodiment, the e-mail message 172 and the MMS message 182 both contain links to location 190 where the recipient mobile devices 174, 184 can access and download the audio-image app 132. The message will also communicate that downloading the app 132 at the link will allow the recipient to create and return an audio reply to this audio-image file. The linked-to download location 190 may be an “app store”, such as Apple's App Store for iOS devices or Google's Play Store for Android devices. The user of either device 174, 184 can use the provided link to easily download the audio-image app 132 from the app store 190. When the downloaded app 132 is initially opened, the users are given the opportunity to register themselves by providing their name, e-mail address(es) and cell phone number(s) to the app 132. The app 132 then shares this information with the audio-image server 160, which creates a new user record in database 164. This database is described in more detailed in the incorporated applications. The server 160 can then identify audio-image messages that were previously sent to that user and forward those messages to the user. At this point, the user can review the audio-image files using the app 132, and now has the ability to create and send a reply audio message as a new audio-image file.

In some embodiments, the audio-image file is delivered as a video file to e-mail recipients and MMS recipients, while in other embodiments the audio-image file is delivered as separate data elements to mobile devices 168 that utilize the audio-image app 132. In other words, a single video file is delivered via an e-mail or MMS attachment, while separate data elements are delivered to the mobile devices 168 that use the audio-image app 132. In these cases, the “audio-image file” delivered to the mobile device 168 would include an image file compressed using a still-image codec (such as JPG, PNG, or GIF), one or more audio files compressed using an audio codec (such as MP3 or AAC), and metadata identifying the creator, creation time, and duration of each of the audio files. The audio-image app 132 would then be responsible for presenting these separate data elements as a unified whole. As explained in the incorporated applications, the audio-image file 166 may further include a plurality of still images, one or more video segments, metadata identifying the order and timing of presentations of the different visual elements, or metadata defining augmentations that may be made during the presentation of the audio-image file.

In sending the MMS message 182, the mobile device 110 may take advantage of the capabilities of the separate MMS app 144 residing on the mobile device 110. Such capabilities could be accessed through an API or SDK provided by the app 144, which is described in more detail below. Alternatively, the audio-image app programming 134 could contain all of the programming necessary to send the MMS message 182 without requiring the presence of a dedicated MMS app 142. Similarly, the mobile device 110 could use the capabilities of a separate e-mail app 144 to handle the transmission of the e-mail message 172 to mobile device 174, or could incorporate the necessary SMTP programming into the programming 134 of the audio-image app 132 itself.

### System 200

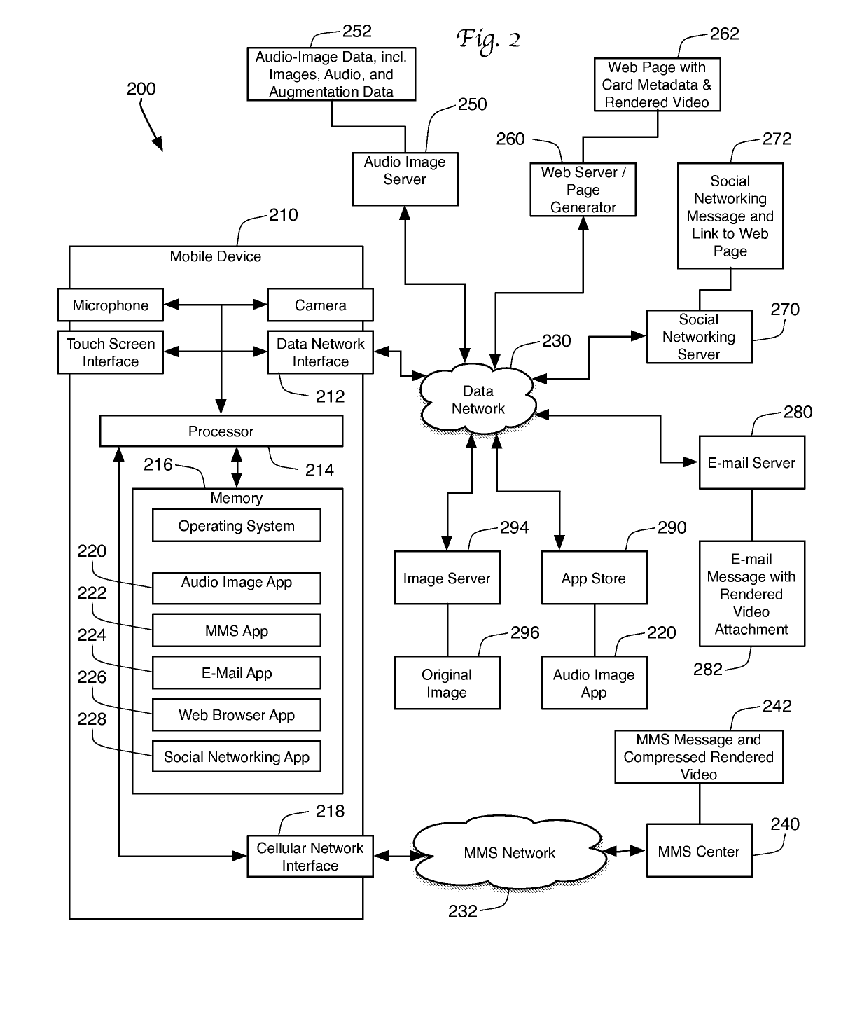

FIG. 2 shows a system 200 that is similar to system 100 described in connection with FIG. 1. However, in system 200 a mobile device 210 is able to communicate audio-image data using one or more of an MMS center 240, an audio-image server 250, a web server 260, a social networking server 270, and an e-mail server 280. E-mail communications take place over data network 230 and utilize an e-mail server 280. The end result of an audio-image e-mail communications is an e-mail message 282 that contains a rendered video attachment of the audio-image message along with a link to the audio-image app 220 available through the app store 290. Similarly, an MMS communication takes place over the MMS network 232 and utilizes an MMS center 240 to handle and deliver MMS messages. The end result of an audio-image MMS communication is an MMS message 242 that also contains a rendered video attachment of the audio-image message along with a link to the audio-image app 122. In the preferred embodiment, the audio-image app 220 operating on the mobile device 210 will render video differently depending on whether the video will be sent along with an e-mail message 282 or an MMS message 242. In particular, the rendered video for the e-mail message will likely be of a higher resolution, resulting in a larger file size than would be appropriate for an MMS message. The ability to vary resolution of the rendered video depending on the method of message transmission allows the user to experience the highest possible resolution without exceeding the capabilities of the transport media.

For audio-image messages that are sent directly via the audio-image server 250, the app 220 allows the user to select an image, record an audio commentary, and create image augmentations. However, rather than rendering a video file from these elements, the app simply transfers this data to the audio-image server 250 which stores the data 252 relating to the audio-image message in a database. The audio-image server 250 informs the recipient of the message, and, when requested by the recipient, sends the message data 252 to the recipient for reconstruction of the audio-image message by the application running on the recipient's device. The processes for creating and sending these e-mail and MMS messages 282, 242 and for sending messages over the audio-image server 250 using audio-image message data 252 are described in the incorporated applications.

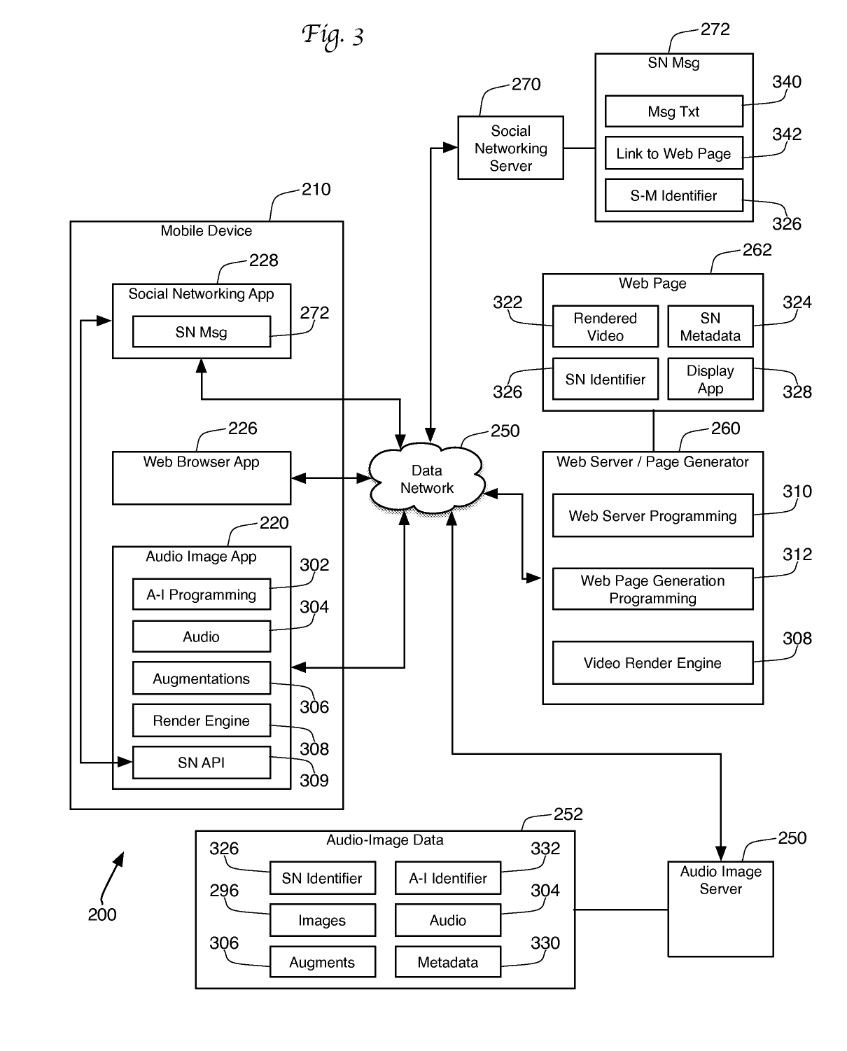

The system 200 extends the capabilities described in these incorporated applications by allowing audio-image data to be communicated over a social networking server 270 using social networking messages such as message 272. Some of the devices, servers, programming, and data required to perform this operation are shown generally in FIG. 2 and in more detail in FIG. 3. To send a social networking message 272, the originator of the communication uses the audio-image app 220 operating on the mobile device 210 to create or select a photograph or other image. In FIG. 2, an image server 294 is shown that is hosting the original image 296 selected by the user of the audio-image app 220. The image 296 is retrieved from the image server 294 and downloaded to the mobile device 210 for use in the audio-image message by audio-image programming 302 in the app 220. The audio-image app 220 is then used to record an audio commentary 304 for the image 296, and the user is given the opportunity to create augmentations 306 that alter the image 296 (such as by zooming or cropping the image, drawing on the image, or by combining multiple images together). To create the social networking message 272, the audio-image app 220 will cause a video file to be rendered. The video file will include the audio commentary, image augmentations, and the image rendered together. This rendering can be done using a rendering engine found on the mobile device 210, such as render engine 308 which is shown in FIG. 3 as part of the audio-image app 220. Alternatively, the render engine could be provided by the operating system programming of the mobile device 210, or could even be found on a web server (such as server 260) that makes video rendering available to the app 220 over the data network 230.

In the selection of the image 296, the creation of audio commentary and augmentations, and the rendering of a video file, the creation of social networking message 272 is no different than the creation of an e-mail message 282 or an MMS message 242. However, rather than incorporating this video file as an attachment to social networking message 272 (as is done in the context of MMS message 242 and e-mail message 282), this video file is instead transmitted to a web server 260. The web server 260 is programmed to assist in the creation of audio-image social networking messages 272. In the embodiment shown in the Figures, the web server 260 contains normal web server programming 310 that serves web pages using the HTTP protocols. The server 260 also contains web page generation programming 312. This programming 312 receives data from the audio-image app 220 and generates web pages 262 that can then be served to other users. In particular, this programming 312 receives the rendered video file and then creates a web page 262 specific for the social networking message 272 that is being created. The web page 262 contains the video file 322 along with metadata 324 that is used by applications 228 that handle social networking messages 272. In the preferred embodiment, the web page 262 is also associated with an identifier 326 that uniquely identifies the social networking message 272 for which the web page 262 was created. This identifier 326 may be the same identifier that is used by the social networking server 270 and the social networking app 228 to identify the message 272. The preferred embodiment also associated the web page 262 with application programming (known as the display app 328) that is able to display and render the audio-image content through any standard web browser, such as web browser 226 operating on the mobile device 210. As explained below in connection with audio-image widgets, programming operating on a web page 262 can allow a user to view audio content of an audio-image message, as well as create an audio response to that message.

During the creation of a social networking message 272 containing audio-image data, the audio-image app 220 also transmits the audio message 304, the image 296, any augmentations 306, and related metadata information 330 to the audio-image server 250 so that it can be stored as data 252 in the server's database. In this way, the audio-image server 250 has access to all of the data 252 necessary for an audio-image app 220 to construct and present the audio-image message. As shown in FIG. 3, the audio-image server 250 also associates this data 252 with the social networking identifier 326 as well as its own audio-image identifier 332. This allows the server 250 to serve data 252 related to any message simply by receiving a request over the network 230 containing either the social networking identifier 326 or the audio-image identifier 332.

In addition to sending data 252 to the audio-image server 250 and to sending the rendered video file to the web server 260, the audio-image app 220 also creates a social networking message 272 and submits the message to the social networking server 270. The social networking server 270 operates the social networking messaging system. These types of social networking messaging systems can take a variety of forms. For the sake of convenience in describing the present invention, this disclosure will describe the social networking messaging system known as Twitter, as provided by Twitter, Inc. (San Francisco, Calif.). The Twitter social networking system is unique in that it limits messages to 140-character “tweets” (the 140 character limit comes from SMS text message's 160 character limit, which allows Twitter 20 characters for user addressing). Tweets can be sent from user-to-user, but more frequently tweets are “broadcast” and received by all users that have chosen to follow the author of the tweet. A user can publish or “post” a tweet by submitting the text of the tweet to the social networking server 270, which then makes the tweet available to followers of the author. An author that has viewed a tweet that they appreciate or otherwise wish to publicize is able to “retweet” a message to their own followers. Tweets frequently contain hashtags (a word or phrases that are preceded by the hash symbol—#), which generally indicates the subject matter of the tweet. The Twitter system has the ability to create replies (known as @replies), which are generally viewed only by the original tweeter and the replying tweeter, along with those followers that follow both parties. Finally, Twitter tracks messages that are sent in reply to other messages, which allows applications such as social networking app 228 to display conversation threads concerning a particular topic.

In the context of Twitter messages, the social networking service does not allow the ability to include video or still images directly into the social networking messages. Rather URL links are provided to a video or image file that is available elsewhere on the network 230. Thus the social networking message 272 that is created by the audio-image app 220 contains a textual message generated by the user as well as a URL link to the web page 262 created by web server 260. Twitter specific applications such as social networking app 228 will analyze this link when they are displaying a message containing a URL link. If the link is to a web page 262 that incorporates the appropriate metadata 324, the social networking app 228 will be able to directly display the media 322 to the user when the user is viewing the message 272. In the preferred embodiment, the web server 260 always configures the web page 262 containing the rendered audio-image video file 322 with such metadata 324.

In FIG. 3, the social networking message 272 sent by the audio-image app 220 is shown as being received by the social networking app 228 running on the same mobile device 210. This is not a normal circumstance, as typically it is a separate user with their own mobile device that wishes to view the social networking message 272 created by the user of device 210. In FIG. 3, the social networking message 272 is shown as being viewed by the same device 210 merely for ease is describing the present invention.

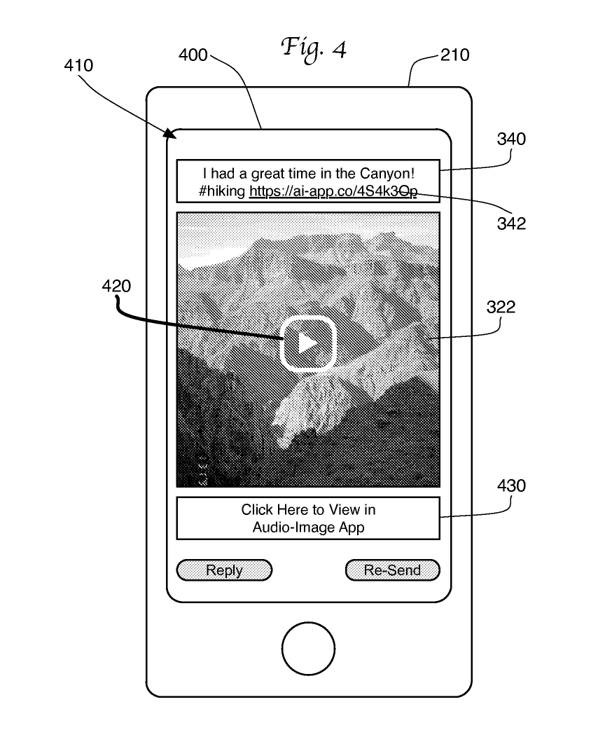

When a recipient user views this message 272, the user will see the message text 340 generated by the sender as well as the link 342 included in the message by the audio-image app 220. This is shown in the screen display 410 (seen in FIG. 4) generated by the social networking app 220 on the device's display screen 400. When the link 342 within the message 272 links to a web page 262 containing the appropriate metadata 324, the social networking app 228 will display the linked-to video file 322 directly from the web server 260. This allows the user to consume the audio-image experience within the social networking application 228. An indicator such as a “play” icon 420 will preferably be placed over an image from the video file 322 (which may be the original image 296) on interface 410 to indicate that the user can play the file 322 by selecting the image. The social networking application 228 will also be able to identify whether the recipient has access to the audio-image app 220 on their current device 210. If so, a button or other link 430 will be provided within the user interface 410 of the social networking app 228 that, when selected, causes the mobile device 210 to open the audio-image message within the audio-image app 220. If the audio-image app 220 is not available, a message will be displayed on the user interface of the social networking app 228 indicating that an audio reply can be created if the user were to download the audio-image app 220. This message will include a link to the app store 290 where the app 220 can be downloaded.

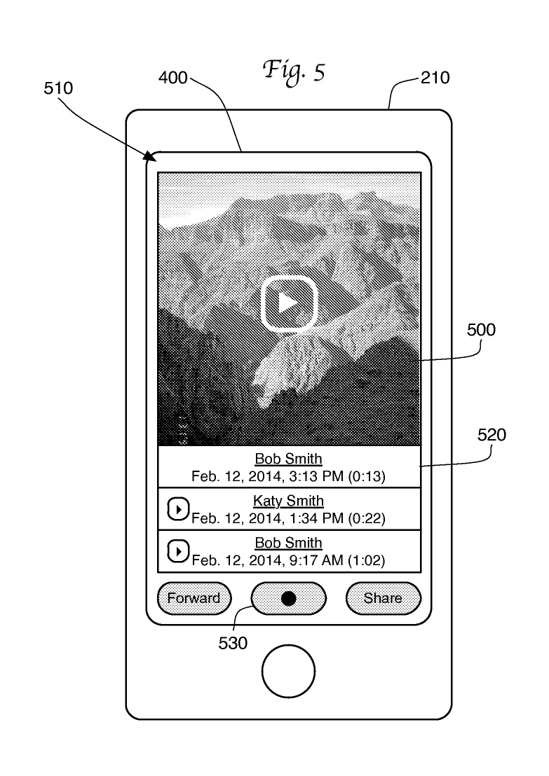

When a user elects to view the message 272 in the audio-image app 220, the social networking app 228 will communicate a message identifier 326 to the audio-image app 220. In one embodiment, the two apps 220, 228 communicate through an application programming interface (or API) that is provided by the social networking service. In this case, programming 309 in the audio-image app 220 implements this API in order to allow this type of communication. By communicating the social networking message identifier 326, the audio-image app 220 is able to request the original data 252 relating to this message from the audio-image server 250. The audio-image app 220 will then display to the user the audio-image content 500, including the original image (or images or video) 296, the audio message 304, and any augmentations 306, using an interface such as interface 510 shown in FIG. 5. This user interface is similar to the interface described in the incorporated applications, and allows a user to select and hear any of the audio commentaries associated with this audio-image content 500 using an audio content list 520.

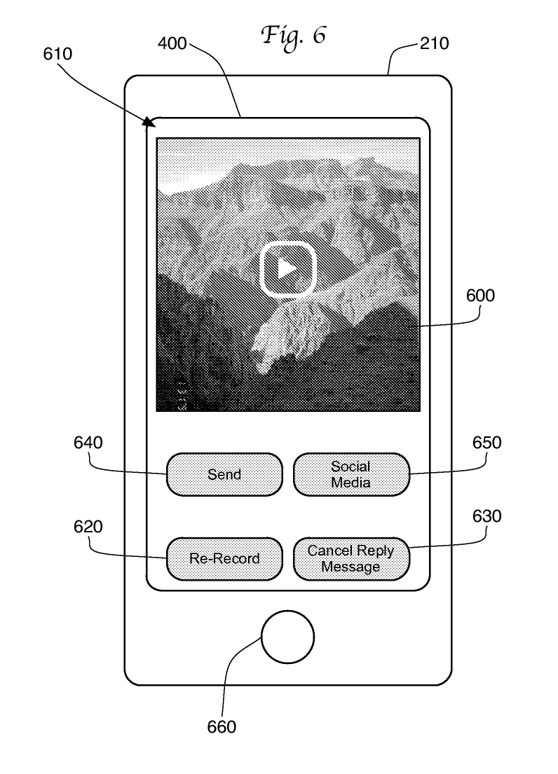

After displaying the audio-image message, the audio-image app 220 will allow the user to record an audio response to the audio-image message, such as by pressing and holding the record button 530. This will create a reply audio message, and may include additional images or image augmentations, as described in the incorporated applications. The audio-image application 220 is able to send the audio-image response to recipients over the social networking server 270 as new social networking messages or directly through the audio-image server 250, or through both channels simultaneously. Alternatively, or in addition, the reply message may be sent or forwarded to users as an e-mail message 282 or an MMS message 240. The sending of audio-image messages through the audio-image server 250 or via the MMS center 240 or e-mail server 280 is described in the incorporated applications. The user will be provided each of these options through user interface 510 after they have completed creating their response to the audio-image content 500. For example, FIG. 6 shows an example user interface 610 that could be presented after revised audio-image content 600 has been created by recording an audio reply. The user still sees an image from the content 600, and is able to replay their audio reply by pressing on the image 600. Alternatively, the user can re-record their message by pressing button 620, or cancel this reply by pressing button 630. In some cases, the user may wish to send this response only through the audio-image server 250, which can be accomplished by pressing the send button 640. The transmission of an audio-image message through the audio-image server 250 will then take place as described above and in the incorporated applications.

If, however, the user indicates a desire to transmit the response via the social networking application by pressing button 650, a new video file will be rendered including both the original audio message and the user's response. The rendering can occur on the user's device, or remotely using a rendering engine 308 on a remote server 260. This new video file will be submitted to the audio-image web server 260 for the creation of a new web page 262 for that response. This web page 262 will contain the newly rendered video file, the text (if any) of the user's social networking message, and the metadata necessary to allow the video file to be properly displayed using the social networking application 228. The audio-image app 220 will then send a social networking message 272 that includes any text entered by the user and a link to the new web page. This message 272 will be handled by the social networking platform 270 like any other message. When it is viewed by the social networking application 228, the social networking application 228 will access the web page 262, receive the metadata 324, and display the video 322 in place to any user viewing the message.

In the preferred embodiment, the audio-image app 220 is able to directly access the in-box (or “feed”) of the user's social networking account (maintained on social networking server 270) to determining if any of the social networking messages 272 for the user contain a link to an audio-image web page 262. If so, the audio-image app 220 will know that the message relates to an audio-image message. The audio-image messages that are received through the social networking platform 270 can be viewed as an in-box/feed within the audio-image app 220, thereby allowing users of the audio-image app 220 to immediately identify and handle social networking messages 272 that contain audio-image data without using the social networking app 228.

### Method for Message Handling 700

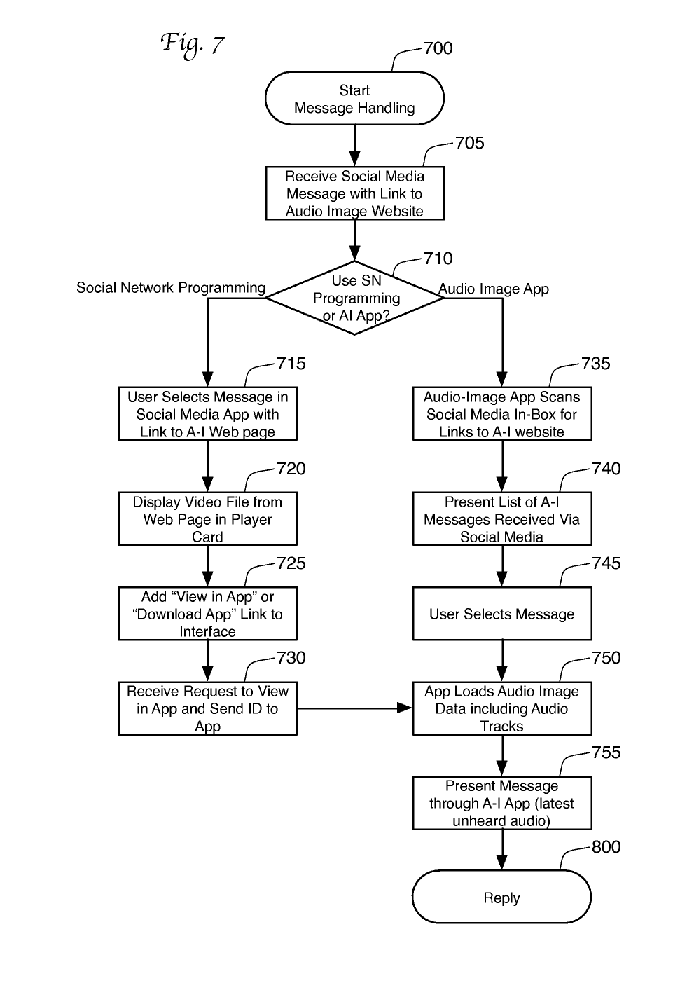

The process described above for handling messages is summarized in the method 700 shown in the flow chart of FIG. 7. This method 700 begins at step 705 when the social networking server 270 receives a social networking message 272 with a link to an audio-image web page 262. In general, social networking messages received by the server 270 can be reviewed by users using that are either using an app or application 228 specially designed for the receipt and handling of the social networking messages, or via a website provided by the social networking server 270. However, this does not have to be the case. Many social networking platforms maintain messages on the social networking server 270 in a manner that allows access to those messages to any application that utilized a provided API to access those messages. Consequently, the second step 710 of method 700 is for the reader of the message 272 to select which method they are going to use to access that message 272. The user can use programming provided by the social networking platform, such as the social networking app 228 or the web site provided by the social networking server 270, or use the audio-image app 220.

If the user uses the social networking app 228 or the social networking web site, the user will select the message 272 for review at step 715. The social networking programming then displays the text content of the message 340 including the link 342 to the web page 262. The social networking programming will determine that the web page 262 linked to in the message contains the appropriate metadata 324, and then will display the rendered video 322 from that web page 262 as part of the social networking message 272. This occurs at step 720. If the user is using the social networking app 228, the app 228 will determine whether or not the audio-image app 220 is available on the device 210. If so, it will display a “view in app” link 430 along with the message 272 at step 725. If not, step 725 will display a “download app” link to the app store 290. The user can now view the rendered video 322 within the social networking programming.

If the user elects to use the audio-image app 220 at step 710, the audio-image app 220 will scan for audio-image messages within the social networking in-box identified for the user of the app 220 in step 735. This scanning can occur by directly accessing the social networking server 270 and reviewing all of the available messages available for viewing by that user. Alternatively, the audio-image app 220 can rely upon the social networking app 228 to download the user's message stream onto the mobile device 210, and then the audio-image app 220 can examine this feed locally on the device 210. The audio-image app 220 identifies relevant messages by finding links within the messages to the audio-image server 250. At step 740, the list of messages containing audio-image content are displayed in the audio-image app 220. When the user selects a message at step 745, the audio-image app 220 contacts the audio-image server 250 and obtains the audio-image content 252 for this message. The audio-image app 220 then presents the audio-image content 252 to the user. Because the audio-image app 220 has access to the separate elements of data that constitute the audio-image content 252, the audio-image app 220 allows the user to select individual audio comments independently. As explained in the incorporated applications, rendered video of an audio-image message will usually render all of the audio tracks consecutively in the rendered video, making it more difficult to directly access a desired track. In the preferred embodiment, the audio-image app 220 and the audio-image server 250 collectively track which audio tracks have been heard by a user. This means that when the audio-image app 220 presents the audio-image message to the user in step 755, the audio-image app 220 is able to present the earliest, unheard audio track by default. When the user has heard an audio track for a message, this information is tracked by the app 220 and forwarded back to the server 250 so that the next viewing of the same message by the user will not repeat this audio track.

Note that at step 730, the social networking programming can receive a request from a user to view a social networking message 272 within the audio-image app 220. When this occurs, the social networking programming communicates a message identifier to the audio-image app 220, and the method transitions to step 750.

### Method for Creating a Reply Audio Message 800

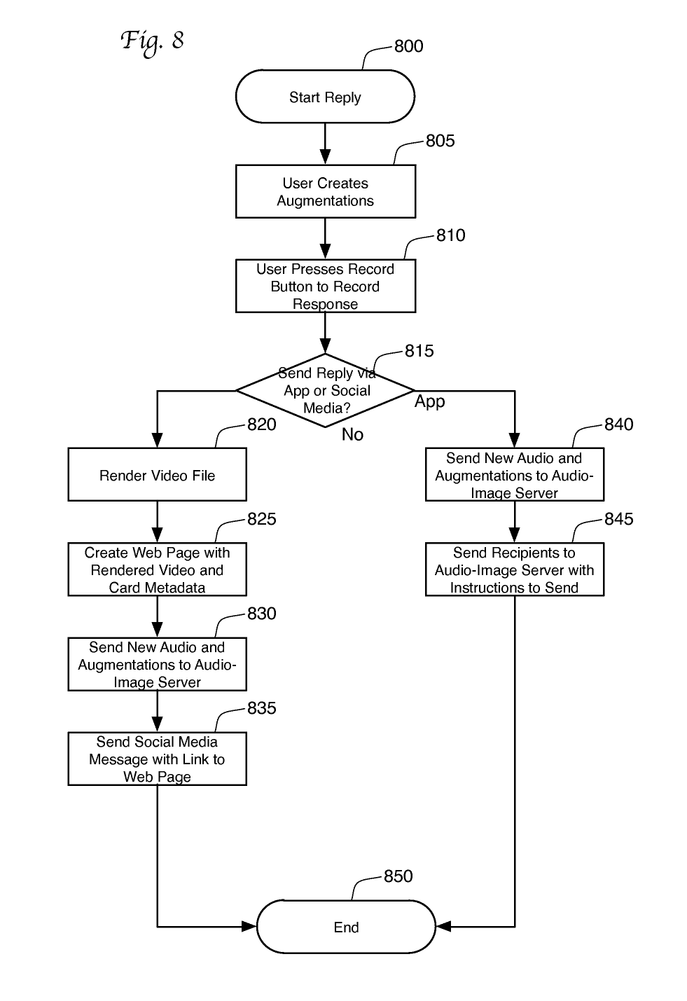

FIG. 8 shows flowchart outlining a method 800 for creating a reply audio message using system 200. To create the reply audio message, the user will be using the audio-image app 220 as opposed to the social networking app 228 (note that a user could also use an audio-image widget to create the audio reply message, as is explained below). To create the reply, the user optionally adds images or other image augmentations in step 805, as is described in the incorporated applications. The user then presses record button 530 on the audio-image interface 510 in order to record an audio message using the microphone on the mobile device 210. The user then determines at step 815 whether they wish to send the reply message via a social networking message 272 or as an audio-image message over the audio-image server 250. In the interface 610 shown in FIG. 6, the user would press the “send” button 640 to send the reply using the audio-image server 250, or press the “social media” button 650 to send the reply in a social networking message 272.

Assuming that the user elected to send a social networking message 272, step 820 will then cause a new video file to be rendered. In the preferred embodiment, this rendered video will contain all of the audio comments associated with the originally selected image 296, as well as the user created augmentations made to this image. As explained above, this rendering can take place on the same computer device 210 where the audio was recorded using a local rendering engine 308. Alternatively, a server 260 may receive the audio file and user-created augmentations and be requested to render the video image remotely. In these cases, the server 260 can access previous audio comments and augmentations from the database maintained by the audio-image server 250, which obviates the need for the mobile device 210 to send anything other than the latest audio track and augmentations to the server 260.

At step 825, the audio-image app 220 requests that the remote server 260 create a web page 272 for this reply message that includes the rendered video 322 and appropriate metadata 324. The server 260 then creates this web page 272 and returns a link to that page 272 to the audio-image app 220. To keep the database maintained by the audio-image server 250 up to date, the audio-image app 220 will also send the new audio commentary and augmentations to that server 250 at step 830. Obviously, data communications could be minimized by having the server 260 that renders the video and creates and maintains the web page automatically send this information directly to the audio-image database server 250. It would also be possible to combine the activities of the web server page generator computer 260 and the audio-image server 250 onto a single server. At step 835, the audio-image app 220 creates a social media message including any text 340 desired by the user and the link 342 to the web page 262 and submits this message 272 to the social networking server 270. The method 800 then ends.

If the user elects at step 815 to send the audio-image reply only via the audio-image server 250, the audio-image app 220 need only send the audio comment and augmentations to the server 250 (step 840) along with a request to send the message to identified recipients (step 845). This is explained in more detail in the incorporated applications.

### Web Programming and Widgets

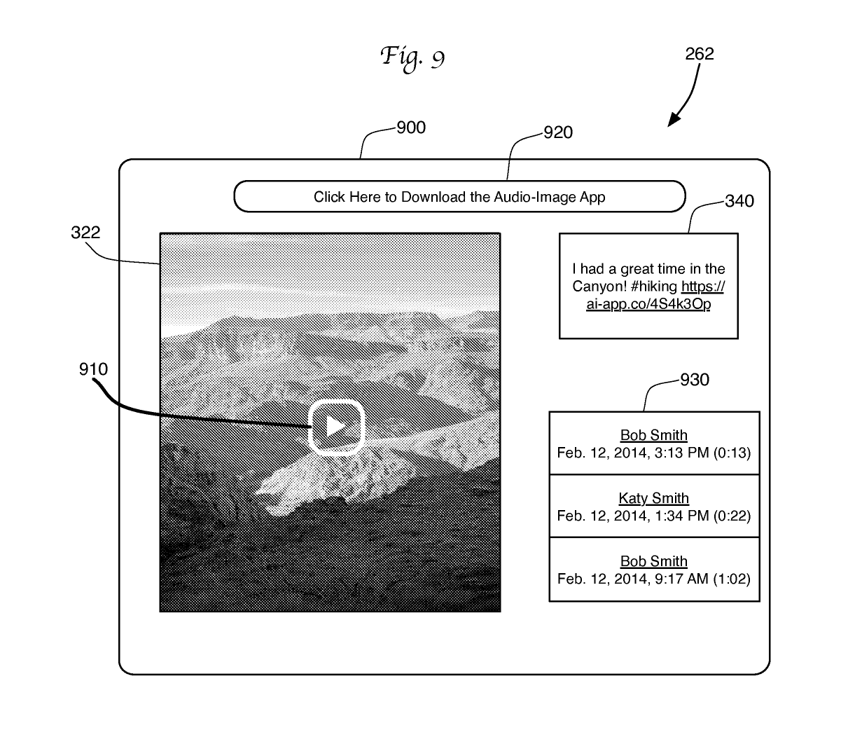

FIG. 9 shows a web page interface 900 that may be displayed when a user accesses web page 262 using a normal web browser, such as web browser app 226. The web page is designed to feature the rendered video 322, and will typically include an icon 910 indicating that the rendered video can be played by simply clicking on the displayed image. The web page interface 900 also shows the text message 340 that was sent along with the rendered video 322 in the associated social networking message 272. In addition, the web interface 900 includes a link 920 that invites the user to download the audio image app 220 from the app store 290. In the current marketplace, this link 920 would probably include separate links to the Apple App Store and the Google Play Store, allowing both iOS and ANDROID devices direct access to the audio-image app 220. In this way, accessing this content via web browser 226 is little different than viewing the same content via the social networking app 228.

In the preferred embodiment, however, the web interface 900 is also able to provide direct access to the various audio commentaries (and associated augmentations) through a menu type interface 930. This interface can be integrated into the image panel for convenient access to these controls. Programming on the web server 260 accesses this information directly from the database maintained by the audio-image server 250. When the user chooses to go directly to a selected commentary, the web server programming will access the necessary files and construct the audio-image message appropriately, much as is accomplished by the audio-image app 132 as discussed in connection with FIG. 5. Through the use of cookies, it is even possible to individually identify viewers of the web page interface 900 and track which audio commentaries they have previously reviewed. When they return to a web page 262 associated with the same audio-message thread, the web server 260 and identify the user and determine the oldest, unheard audio commentary in the thread.

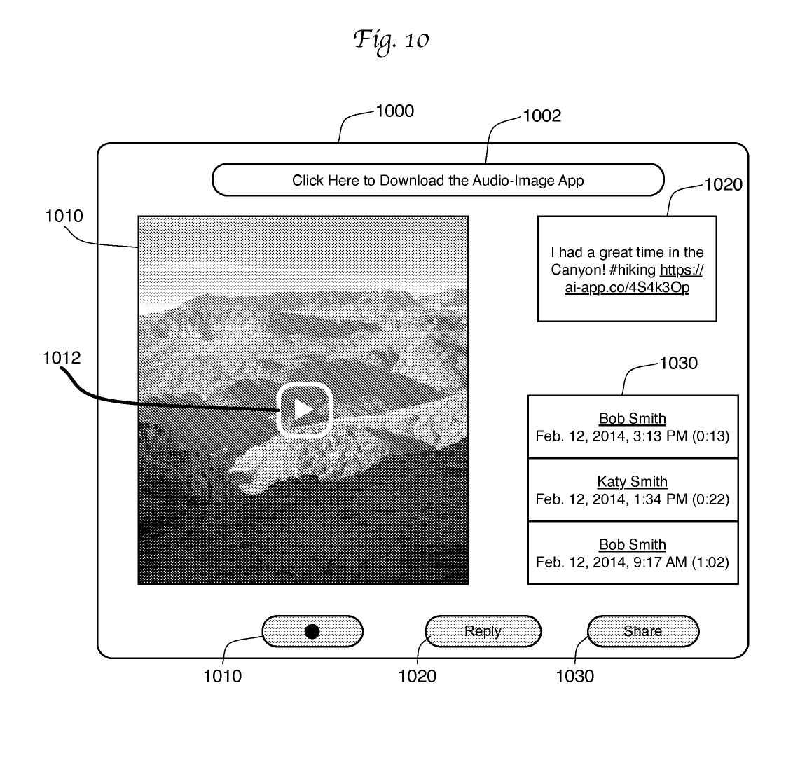

After the web user has viewed the audio commentary, the web server 260 can allow the user to record his or her own audio response, as is shown in web interface 1000 in FIG. 10. This interface 1000 is similar to the presentation interface 900, but includes a record button 1010. After pressing the record button 1010, the user's device microphone will record an audio commentary of the user related to the displayed audio-image content. Once the user records their audio commentary, the user can hit the social networking reply button 1020 to have the web server 260 generate an social networking message 272 responding to the original social networking message that formed the basis of web page 262. If the reply message is send as a social networking message 272, the web server 260 will render a new video containing this reply message, generate a new web page, and provide a link to the new web page in the social networking message 272. The user could also hit the share button 1030, which would give the user the ability to share their reply via e-mail, MMS message, or an audio-image message handled by the audio-image server 250.

The same web programming that provides the capabilities for interface 900 and 1000 could also be made available to bloggers and web site developers in the form of an audio-image “widget.” In this context, a widget is programming code designed to provide functionality to another program or programming environment. Most bloggers utilize blogging software such as WordPress (provided by the WordPress Foundation of Redwood City, Calif.). WordPress allows third parties to generate and share widgets that can be used by bloggers to add additional capabilities to their blogs. The audio-image widget allows a user to add audio-image content to a blog web page without associating that content with a user-to-user message or even a social networking broadcasted message. Rather, the audio-image content is associated with a particular location of a blogger's web page as identified by the widget.

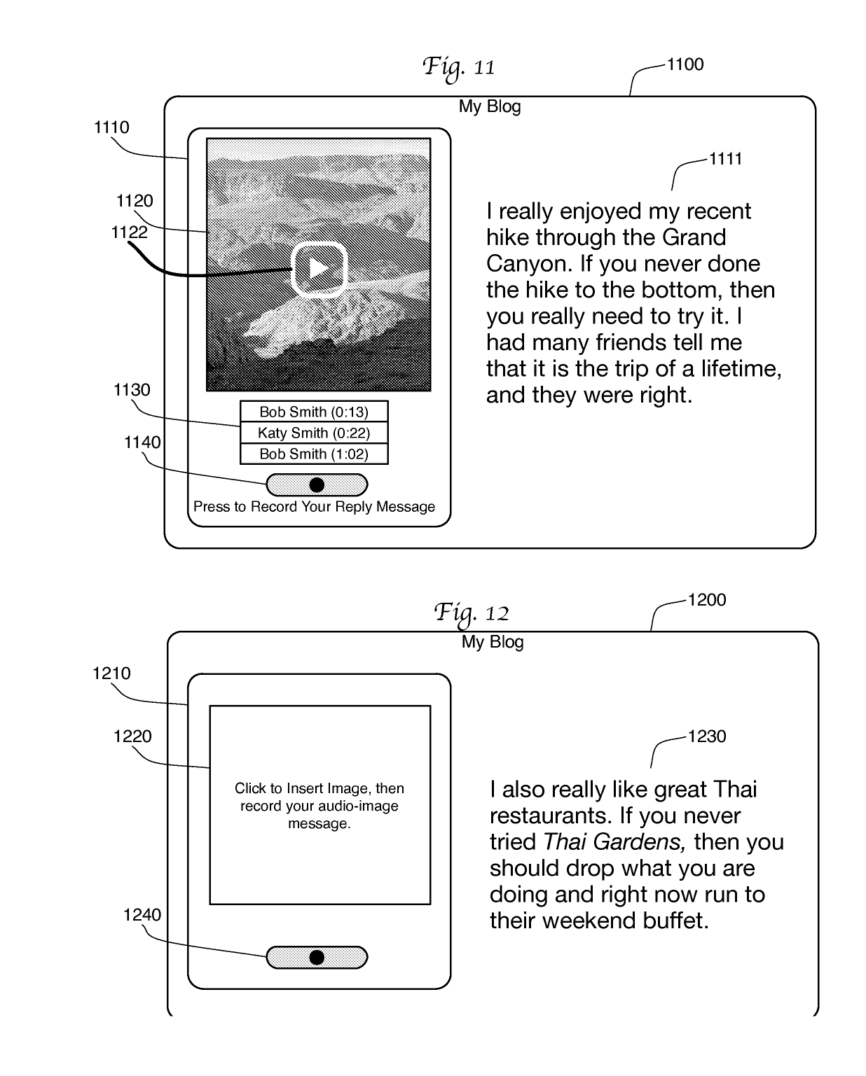

An example of a blogger's use of the audio-image widget is shown in blog interface 1100 shown in FIG. 11. On this blog page, the user has inserted an audio-image widget 1110 that contains photograph 1120. This widget 1110 is associated with text 1111 that describes the photograph 1120. When a user views this blog interface 1100, they will see the photograph 1120 as presented by the widget 1110 along with an icon 1122 that encourages the user to play the audio content associated with the photograph 1120. In the preferred embodiment, the viewer will also see a menu 1130 showing all of the audio commentaries that have been made concerning this image 1120. The interface 1100 will even include a record button 1140, which encourages the user to add a new audio commentary to this audio-image content. In this way, the widget 1110 operates in much the same fashion as web interface 1000 and audio-image app interface 510. The data used by the widget 1110 is stored as audio-image data 252 by the audio-image server 250. Additional audio commentaries recorded through the widget 1110 are transmitted to the audio-image server 250 and stored with the other audio-image data 252 for that image 1120.

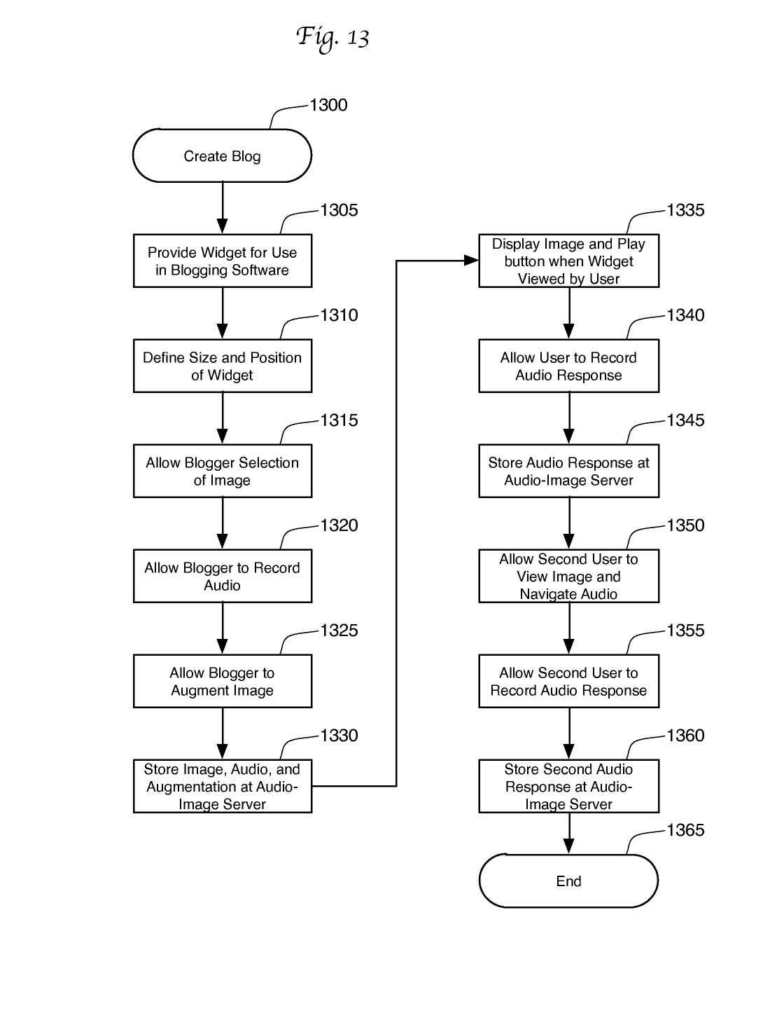

The use of an audio-image widget 1210 to create a new blog entry is shown in interface 1200 on FIG. 12. A method 1300 for using this interface 1200 is shown in flow-chart form in FIG. 13. The method 1300 starts with programming the audio-image widget 1210 at step 1305. Typically the entity that maintains the audio-image server 250 and web server 260 will program the audio-image widget 1210 and then make it available to web site and blog authors. The author incorporates the widget 1210 into their web site or blog entry, and then resizes and repositions the widget as appropriate in step 310. The author would then select a photograph (or video clip or group of photographs) for incorporation in the audio-image widget 1210 at step 1315. Screen 1220 explains to the author that the image can be selected and inserted simply by selecting screen 1220. After selecting the image, the author would press the record button 1240 to record their audio commentary for that image (step 1320). In some embodiments, the widget 1210 would also be programmed to allow the author to augment the image at step 1325. At this point, the widget 1210 will store the selected image, recorded audio, and any image augmentations at the audio-image server 250 as audio-image data 252. The author would write text 1230 for the web site or blog, which may provide a written description or commentary concerning the image. The combined text 1230 and audio-image widget 1210 would then be published for readers to review.

When a blog entry 1230 is published, readers could utilize the audio image widget 1210 in the same manner as widget 1110 described above. This occurs at step 1335. The user is invited to record their own audio reply message, which they do by pressing the record button (element 1140 on FIG. 11) at step 1340. This audio reply is then stored at the audio-image server 250 as additional audio-image data 252 associated with this image (step 1345). When a second reader views this blog post at step 1350, they will see both the original audio and the first reply message listed in the audio menu 1130 displayed with the image 1120. The second reader can navigate these audio messages as desired. The second reader can then record his or her own audio response by pressing record button 1140 (step 1355). This data is also stored by the audio-image server 250 in association with this image at step 1360, which allows future viewers to hear this audio commentary as well. The method 1300 then ends at step 1365.

Note that while the widgets 1110, 1210 are sometimes described above in connection with blogging software such as WordPress, it is well within the scope of the present invention to allow the widget to be used on any web page. This can be accomplished by providing users with the HTML code necessary to embed the widget into the HTML of any other web page. The resulting widget could include a password protect “edit this audio-image” link that allows a viewer of the web page to log into the audio-image server 250 and manage a particular audio-image. For instance, a user could visit a web page to create a new audio-image associated with their username and password. This web page would give the user an HTML snippet that could be included in their own web page (or blog page, etc.). When viewing the web page through any browser, the user could click on the edit link, input their username and password, and upload a photograph, augmentations, and an original audio message for this audio-image. Later users could view the photograph and augmentations, listen to the original audio message, and record their own replay without having to enter the creator's username or password.

The widget concept can be used to provide audio-image content to other types of social networking sites including image sharing social media services. Pinterest (by Pinterest, Inc. of San Francisco, Calif.) is an example social networking image sharing website that allows a user to “pin” photographs to a personal “board” on the Pinterest network. Other social networking image sharing websites work similarly.

As users are allowed to make their board's public, other users may choose to follow and review the images “pinned” by celebrities or other personalities. Some users become popular for their photography boards and develop a following as a result of their particular style or ability to find interesting images. Since each photograph on a board includes a link to a web page containing the photograph, many users will first create a blog containing and describing a photograph, and then pin that image with a link back to that blog entry. Other users that find the pinned photograph can re-pin it to their board, which will also include a link back to the original blog entry.

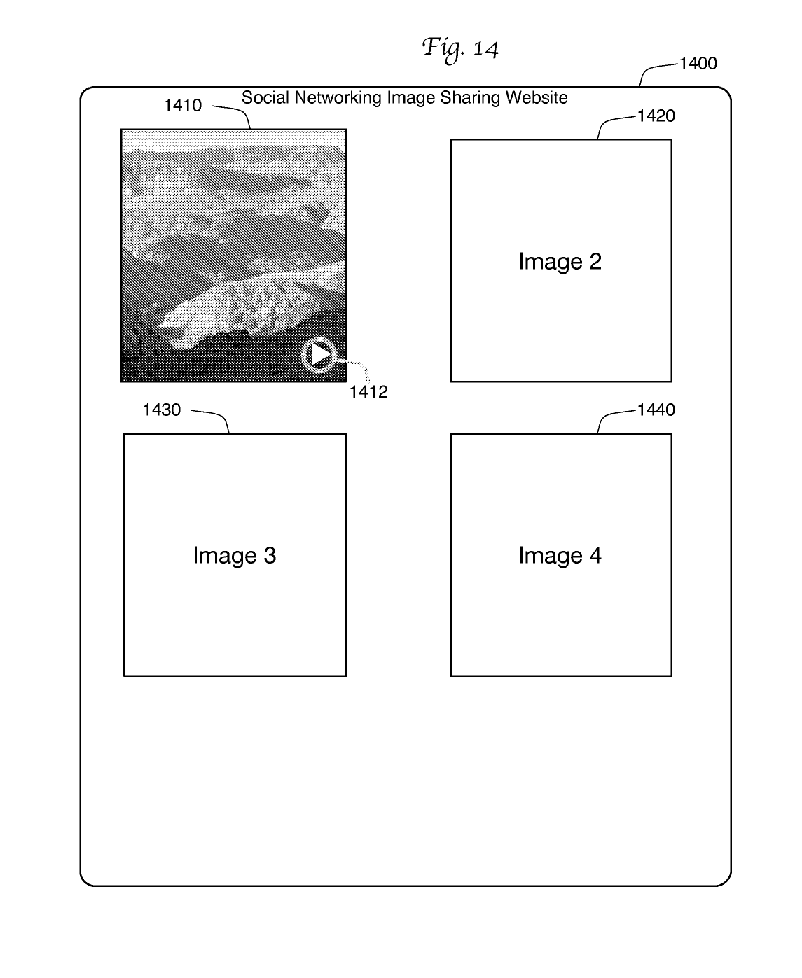

As seen in FIG. 14, a user may have an account or “board” on a social networking image sharing website 1400 that contains four images: an audio-image 1410 and three normal images 1420, 1430, and 1440. In one embodiment, the audio-image 1410 is shown with an icon 1412 indicating that the displayed image is actually a video. Some social networking image sharing sites allow users to “pin” videos directly to their board. When a view wishes to see the pinned video file, a new page on the social networking image sharing site is opened and the video is played. In this embodiment, a blogger that created blog entry 1111 will need a video file that can be “pinned.” Unlike other embodiments of the audio-image concept, the audio-image widget 1110 does not operate using a rendered video file, but instead generates the audio-image content 1120 as needed based on the audio-image data 252 maintained by the audio-image server 250. Nonetheless, a button can be placed on interface of audio-image widget 1110 that allows a user to “pin” a rendered video file containing the audio-image content. In this embodiment, the rendered video is found on the blog entry web page 1100 but is not actually displayed as it would duplicate the content available through the widget 1110. The button selects this hidden video as the video being pinned on the social networking image sharing website. When a user of that website wishes to view the video, the social networking image share website will generate a new page allowing that video file to be played along with a link to the blog entry 1111. The user can describe the video and can mention that the original blog entry should be visited if the user wishes to add his or her audio commentary to the audio-image content.

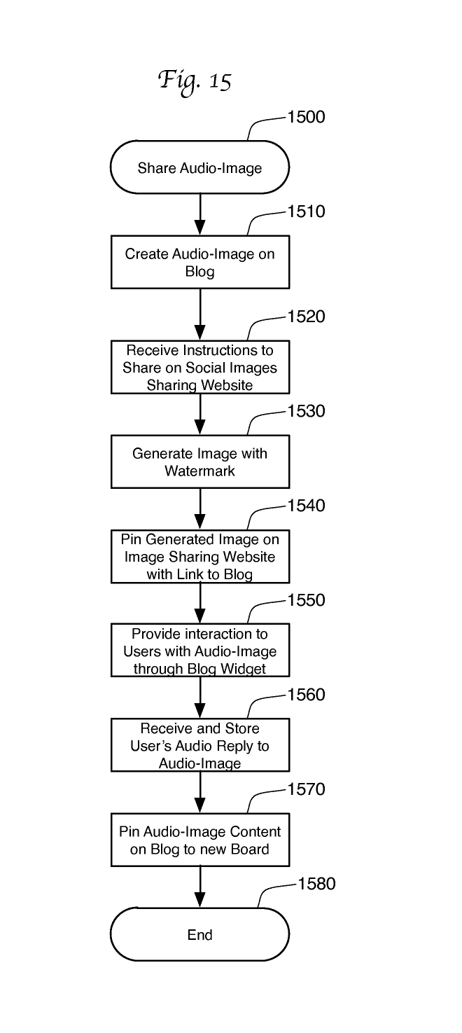

In a second embodiment, only a still image from the audio-image content in widget 1110 is pinned to the social networking image sharing website. This embodiment is implemented using method 1500 shown in the flow chart of FIG. 15. The method 1500 begins at step 1510 with a user creating an audio-image on a blog page 1100 using an audio-image widget 1110, 1120. The blog author then indicates a desire to share the audio-image content on the social networking image sharing website 1400 at step 1520. In some embodiments, this is accomplished by selecting an icon or button (such as a “Pin it!” button) on the interface provided by the widget. By making this button available when the widget is being seen by readers of the blog as well as the author, anyone can pin the audio-image content to the social networking image sharing website.

In method 1500, only a still image is shared with the social networking image sharing website 1400. This still image 1410 may be created at step 1530 in a format specially configured for the website 1400, such as by including a watermark 1412 on the image showing that the image 1410 has audio content associated with it. This specially created image 1410 is then shared with the social networking image sharing website 1400 using the standard API created by the website (step 1540). When the shared image 1410 is displayed on website 1400, it will include a link back to the blog page 1100. Users that follow this link will return to the blog page 1100 incorporating the audio-image widget 1110. As explained above, users can interact with this widget to review the audio commentaries associated with the image, view any augmentations associated with the image, and even add their own audio commentary to the image. This takes place in step 1550. At step 1560, the users' new additions to the audio-image content (such as a reply message) are stored by the audio-image server 250 in audio-image data 252 so that the next viewer will be able to appreciate this viewer's comments. The viewer would then be free to pin this audio-image image 1410 to their own social networking website board at step 1570. The method 1500 then ends at step 1580.

The many features and advantages of the invention are apparent from the above description. Numerous modifications and variations will readily occur to those skilled in the art. For instance, the above embodiments describe a social networking application 228 that displays a linked-to rendered video file 322 when displaying a social networking message 272. In these embodiments, it was necessary to create a web page with the rendered video file 322 and the appropriate metadata 324 in order to conform with the requirements of the social networking programming 228. In other embodiments, the social networking programming 228 will recognize a link to an audio-image web page that does not contain a rendered video file 322 but instead contains an audio-image widget 1110. As explained above, the widget 1110 does not use a rendered video file 322, but instead directly accesses the audio-image data 252 and creates the user interface 1120 on-the-fly, allowing direct access to desired audio commentaries through menu 1130. When the social networking programming 228 is programmed to recognize web pages containing the audio-image widget 1110, it will not be necessary to create web pages 262 with specially rendered video files 322. Since such modifications are possible, the invention is not to be limited to the exact construction and operation illustrated and described. Rather, the present invention should be limited only by the following claims.

What is claimed is:

1. A computerized method comprising:
a) at a mobile device, selecting a visual image;
b) using a microphone embedded in the mobile device to record an audio commentary relating to the visual image;
c) at the mobile device, causing the visual image and the audio commentary to be rendered into a video file showing the visual image along with the audio commentary;
d) at the mobile device, causing the video file to be submitted to a web page creation server;
e) at the mobile device, receiving from the web page creation server a URL of a new web page created by the web page creation server, the new web page containing the video file;
f) at the mobile device, generating a social networking message containing the URL; and
g) at the mobile device, submitting the social networking message to a social networking server for posting of the social networking message.

2. The computerized method of claim 1, wherein the visual image is a single image.

3. The computerized method of claim 1, wherein the visual image is selected from a set comprising a plurality of images and a video clip.

4. The computerized method of claim 1, wherein the video file is rendered on the mobile device.

5. The computerized method of claim 1, wherein the step of causing the video file to be rendered further comprising transmitting the visual image and the recorded audio commentary to a remote server over a network for rendering at the remote server.

6. The computerized method of claim 5, wherein the step of causing the video file to be submitted to the web page creation server further comprising instructing the remote server that renders the video file to further cause the creation of the new web page containing the video file.

7. The computerized method of claim 1, wherein the new web page contains metadata formatted to allow the social networking server to display the video file simultaneously with a display of the social networking message.

8. The computerized method of claim 1, wherein the social networking server accepts only social networking messages that do not contain attached video files and that contain textual content of a length no greater than 160 characters.

9. The computerized method of claim 1, further comprising:
h) at the mobile device, submitting the visual image and the audio commentary to a remote database server for storage in an audio image database.

10. The computerized method of claim 9, further comprising the steps of identifying an identifier for the social networking message and submitting the identifier along with the visual image and the audio commentary to the remote database server for storage in the audio image database.

11. The computerized method of claim 9, wherein the step of submitting the visual image and the audio commentary to the remote database server causes the video file to be rendered and causes the creation of the web page by the new web page creation server.

12. The computerized method of claim 11, wherein the remote database server and the web page creation server comprise a single server.

13. A computerized method comprising:
a) at a mobile device, using a social networking app to view a social networking message containing an identifier and a link to a web page that contains a video file, the video file including a visual image and a message audio commentary on the visual image;
b) at the mobile device, detecting that the web page contains Meta data describing the video file;
c) at the mobile device, using the social networking app to view the video file;
d) at the mobile device, receiving a request to open a specialized app to view the social networking message;
e) at the mobile device, sending the identifier from the social networking app to the specialized app;
f) at the mobile device, sending the identifier from the specialized app to a remote server to request content relating to the social networking message;
g) at the mobile device, receiving the content in the form of the visual image and the message audio commentary, wherein the visual image and the message audio commentary are not rendered together into the video file; and
h) at the mobile devices, using the specialized app to present the message audio commentary and the visual image.

14. The computerized method of claim 13, wherein the message audio commentary includes a plurality of audio comments, and further wherein the specialized app allows a user to separately play each of the plurality of audio comments.

15. The computerized method of claim 14, wherein the plurality of audio comments are presented in an audio comment list shown on a display screen of the mobile device.

16. The computerized method of claim 13, further comprising:
i) using a microphone embedded in the mobile device to record an additional audio commentary relating to the visual image;
j) at the mobile device, causing the visual image, the message audio commentary, and the additional audio commentary to be rendered into a new video file showing the visual image along with the audio commentaries;
k) at the mobile device, causing the new video file to be submitted to a web page creation server;
l) at the mobile device, receiving from the web page creation server a URL of a new web page created by the web page creation server that contains the new video file;
m) at the mobile device, generating a new social networking message containing the URL; and
n) at the mobile device, submitting the new social networking message to a social networking server for posting of the social networking message.

17. A mobile device comprising:
a) a microphone;
b) a network connection to a data network;
c) a processor for executing programming instructions;
d) a program memory containing programming that causes the processor to:
i) select a visual image;
ii) record an audio commentary relating to the visual image over the microphone;
iii) cause the visual image and the audio commentary to be rendered into a video file showing the visual image along with the audio commentary;
iv) use the network connection to cause the video file to be submitted to a web page creation server;
v) receive over the network connection and from the web page creation server a URL of a new web page created by the web page creation server that contains the video file;
vi) generate a social networking message containing the URL; and
vii) submit over the network connection the social networking message to a social networking server for posting of the social networking message.

18. A computerized method comprising:
a) at a computer having a processor and programming instructions stored in a non-transitory memory, creating a blog post containing text describing an image;
b) at the computer, selecting an image utilizing an audio-image software widget;
c) at the computer; recording an audio commentary through a microphone attached to the computer, the audio commentary relating to the image utilizing the audio-image software widget;
d) at the computer, causing the blog post to be posted to the Internet by:
i) submitting the text to a blog hosting server;
ii) submitting through the audio-image software widget the image and the audio commentary to an audio-image server;
e) at the computer, receiving a request to pin the image to a social networking image sharing website;
f) submitting to the social networking image sharing website content relating to the image and a link to the blog post.

19. The computerized method of claim 18, wherein the blog post residing on the blog hosting server includes audio-image programming that accesses the audio-image server, further wherein viewers of the blog post served by the blog hosting server interact with the audio-image server.

20. The computerized method of claim 19, wherein the audio-image server presents the image and the audio commentary to viewers of the blog post.

21. The computerized method of claim 20, wherein the image and the audio commentary are not stored separately at the audio-image server.
